(19) United States
(12) Patent Application Publication
(10) Pub. No.: US 2007/0107858 A1
(43) Pub. Date: May 17, 2007

(54) Collapsible auto shade

(76) Inventor: Sunny en Liung Huang, Claremont, CA (US)

Correspondence Address: Paul M. Denk;Suite 170, 763 S. New Ballas Rd., St. Louis, MO, 63141, US

(21) Appl. No.: 11/648,084

(22) Filed: Dec. 29, 2006

Related U.S. Application Data
(63) Continuation of application No. 10/735,967, filed on Dec. 15, 2003.
Application No. 10/735,967 is a continuation-in-part of application No. 10/610,848, filed on Jun. 30, 2003, now abandoned.
Application No. 10/610,848 is a continuation-in-part of application No. 10/307,482, filed on Dec. 2, 2002, now abandoned.
Application No. 10/307,482 is a continuation-in-part of application No. 10/116,946, filed on Apr. 8, 2002, now Pat. No. 6,691,762.
Application No. 10/116,946 is a continuation-in-part of application No. 09/766,557, filed on Jan. 19, 2001, now Pat. No. 6,561,257.
Application No. 09/766,557 is a continuation of application No. 09/417,277, filed on Oct. 13, 1999, now Pat. No. 6,192,967.
Application No. 10/307,482 is a continuation-in-part of application No. 10/118,549, filed on Apr. 8, 2002, now Pat. No. 6,705,381.
Application No. 10/307,482 is a continuation-in-part of application No. 09/766,557, filed on Jan. 19, 2001, now Pat. No. 6,561,257.
Application No. 09/766,557 is a continuation of application No. 09/417,277, filed on Oct. 13, 1999, now Pat. No. 6,192,967.
(60) Provisional application No. 60/104,703, filed on Oct. 19, 1998.
(60) Provisional application No. 60/284,967, filed on Apr. 19, 2001.
(60) Provisional application No. 60/104,703, filed on Oct. 19, 1998.

(51) Int. Cl. B60J 1/20

(52) U.S. Cl. 160/370.21

(57) ABSTRACT

A collapsible shade is provided that includes at least one material portion having an outer edge defining a perimeter boundary and at least one compressible member attached to the outer edge of the at least one material portion and extending beyond the perimeter boundary of the at least one material portion. The compressible member includes a first and a second opposed end attached to the outer edge of the material portion and forms at least one arc between the first and second opposed ends when attached to the outer edge of the material portion. The compressible member also has an open configuration associated with an open state of the shade, and a collapsed configuration associated with a collapsed state of the shade and is adapted to transfer compressive forces to the outer edge of the material portion.

### CROSS-REFERENCE TO RELATED APPLICATIONS

This is a continuation of application Ser. No. 10/735,967, filed Dec. 15, 2003, which is a continuation in part of co-pending application Ser. No. 10/610,848, filed Jun. 30, 2003, which is a continuation-in-part of application Ser. No. 10/307,482 filed Dec. 2, 2002, which is a continuation-in-part of application Ser. No. 10/116,946 filed Apr. 8, 2002, which is a continuation-in-part of application Ser. No. 09/766,557 filed Jan. 19, 2001, which is a continuation of application Ser. No. 09/417,277, filed Oct. 13, 1999, now U.S. Pat. No. 6,192,967, which claims benefit of provisional application Ser. No. 60/104,703, filed Oct. 19, 1998. application Ser. No. 10/307,482, noted above, is a continuation-in-part of Ser. No. 10/118,549 filed Apr. 8, 2002, which claims priority to provisional application Ser. No. 60/284,967 and a continuation-in-part of application Ser. No. 09/766,557 filed Jan. 19, 2001, which is a continuation of application Ser. No. 09/417,277, filed Oct. 13, 1999, now U.S. Pat. No. 6,192,967, which claims benefit of provisional application Ser. No. 60/104,703, filed Oct. 19, 1998. All of the above noted applications and patents are incorporated herein by reference.

### STATEMENT REGARDING FEDERALLY SPONSORED RESEARCH

Not Applicable.

### BACKGROUND OF THE INVENTION

The present invention relates generally to collapsible shades designed for use in windows, such as automobile windows, so as to protect the interior by preventing the entrance of damaging sunrays and the generation of damaging heat.

Numerous styles of window screens and shades adapted for use in automobiles have long been available in the art. For example, U.S. Pat. No. 5,035,460 for an automobile window protector, which is incorporated herein by reference, shows the fabrication of such a screen, made of flexible material, which could be applied to either the interior or the exterior of the window of an automobile. In addition, U.S. Pat. No. 5,024,262, and which is incorporated herein by reference, shows a compactly foldable automobile sunshade, which provides for inherent resiliency, at least around its perimeter loop, to hold the shade in an opened configuration, and to provide sunlight protection at the vicinity of the automobile window, but which is capable of significant reduction in size through the folding of the frame into a more compact arrangement for suitable for storage.

During use, an automobile windows shade is typically installed adjacent an automobile window, to block incoming sunlight or provide interior privacy. However, if the automobile window and the shade do not have exactly the same dimensions, the shade may not function as desired. For example, if the window shade is smaller than the window in which it is installed, it may not stay in place without the aid of mounting elements or ties to hold it to the window. Alternatively, if the shade is larger than the window in which it is installed, the shade may bow or wrinkle when fitted into the perimeter of the window, leaving gaps or causing damage to the shade.

Accordingly, there is a need for an automobile window shade support assembly which allows a collapsible or folding automobile window shade to securely fit within a wide variety of automobile windows of varying shapes and sizes which are larger than the shade without bowing, wrinkling, or experiencing damage, and without the need for mounting elements or ties.

### BRIEF SUMMARY OF THE INVENTION

Briefly stated, and in one aspect, the present invention comprises a collapsible shade comprising at least one material portion having an outer edge defining a perimeter boundary and at least one compressible member attached to the outer edge of the at least one material portion and extending beyond the perimeter boundary of the at least one material portion, wherein the at least one compressible member comprises a first and a second opposed end attached to the outer edge of the at least one material portion, wherein the compressible member forms at least one arc between the first and second opposed ends when attached to the outer edge of the material portion, wherein the at least one compressible member has an open configuration associated with an open state of the shade, and a collapsed configuration associated with a collapsed state of said shade, and wherein the at least one compressible member in the open configuration is adapted to transfer compressive forces to the outer edge of the material portion.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is front view of one embodiment of the collapsible shade of the present invention, illustrating a circular support assembly integrated with a generally rectangular screen;

FIG. 1A is an enlarged view of the mounting of the screen to the frame of the shade.

FIG. 2 is front view of one embodiment of the collapsible shade of the present invention, illustrating a circular support assembly integrated with a generally square screen;

FIG. 3 is a front view of one embodiment of the collapsible shade of the present invention, illustrating a compressible member support assembly disposed adjacent one edge of a rectangular screen;

FIG. 4 illustrates the flexible support member of FIG. 3 secured to the edge of the rectangular screen, defining a pair of compressible bulges;

FIG. 5 is front view of one embodiment of the collapsible shade of the present invention, illustrating a circular support assembly secured to a generally rectangular screen;

FIG. 6 is a front view of one embodiment of the collapsible shade of the present invention, illustrating a support assembly comprising a plurality of compressible members secured adjacent to the corners of a generally rectangular screen;

FIG. 7 is a perspective view of one embodiment of the collapsible shade of the present invention, illustrating a support assembly comprising a plurality of opposing compressible members secured to the perimeter of a circular screen;

FIG. 8 is a perspective view of a three-piece folding shade, with each piece including the flexible support member of FIG. 3;

FIG. 9 is a perspective view of a multi-piece folding shade, with a pair of pieces including the flexible support member of FIG. 3;

FIG. 10 is a perspective view of an automobile with various embodiments of the collapsible shades of the invention installed in the front and side windows;

FIG. 11 is a perspective view of an automobile with the embodiment of the collapsible shade of FIG. 6 installed in the rear window;

FIG. 12 is an exploded perspective view of a sliding clamp assembly utilized to secure a flexible support member of the present invention to a shade perimeter;

FIG. 13 is a sectional view of the sliding clamp assembly of FIG. 12;

FIG. 14 is an exploded perspective view of an alternate embodiment sliding clamp assembly;

FIG. 15 is a perspective of the alternate embodiment sliding clamp assembly of FIG. 14;

FIG. 16 is a perspective view of another alternate embodiment sliding clamp assembly;

FIG. 17 is a perspective view of a rigid mounting element utilized to secure a shade to a vehicle window perimeter;

FIG. 18 is a front view of one embodiment of a collapsible shade of the present invention with a plurality of rigid mounting elements of FIG. 17;

FIG. 19 is a front view of one embodiment of a collapsible shade of the present invention with the pair of rigid mounting elements of FIG. 17 disposed on a flexible support member of FIG. 3;

FIG. 20 is a front view of one embodiment of a collapsible shade of the present invention with the pair of rigid mounting elements of FIG. 17 disposed on a flexible support member of FIG. 4;

FIG. 21 is a front view of one embodiment of a folding shade of the present invention with a pair of rigid mounting elements of FIG. 17 disposed on either end of an expanding support shaft;

FIG. 22 is a perspective view of an alternative shade, similar to the shade of FIG. 1, but provided with a pocket;

FIG. 23 is a perspective view-of an alternative shade, similar to the shade of FIG. 3, but provided with a pocket and showing that a sign can be placed in the pocket;

FIGS. 24 and 25 are plan views showing alternative manners of applying the compressible member to the shade;

FIG. 26 is a front view of an alternative embodiment of the collapsible shade of the present invention, illustrating a support assembly comprising a plurality of compressible members secured about various positions to a generally rectangular screen;

FIG. 27 is a front view of an alternative embodiment of the collapsible shade of the present invention, illustrating a support assembly comprising a plurality of compressible members secured to the top and bottom of a generally rectangular screen;

FIG. 28 is a front view of an alternative embodiment of the collapsible shade of the present invention, illustrating a support assembly comprising a plurality of compressible members secured to the sides of a generally rectangular screen; and

FIG. 29 is a front view of an alternative embodiment of the collapsible shade of the present invention, illustrating a support assembly comprising a generally curved compressible member.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

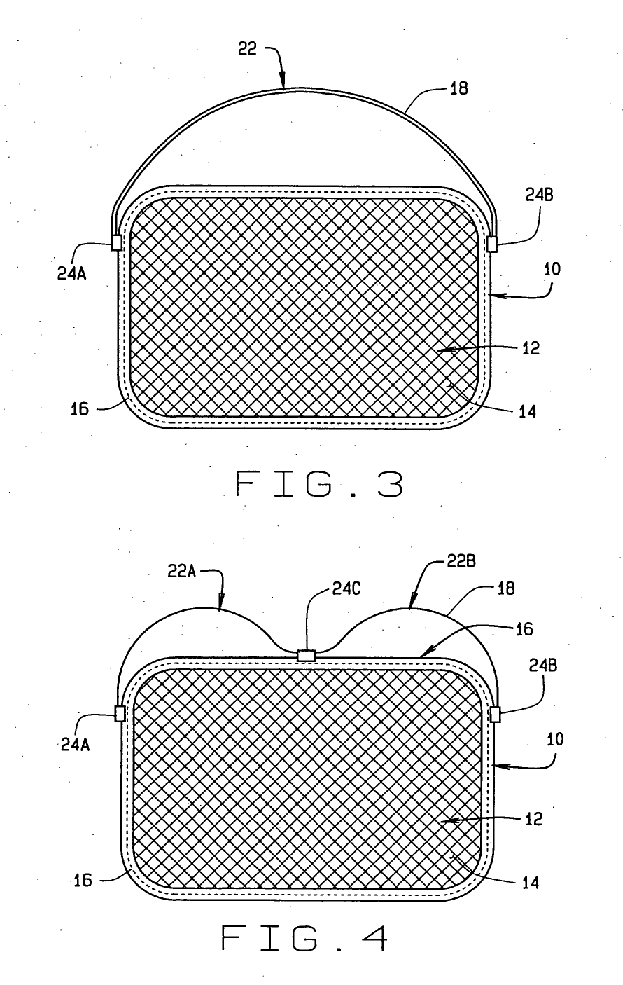

With reference to the drawings, the collapsible shade 12 of the invention comprises at least one material or shade portion 14 having an outer edge 16 defining a perimeter boundary and at least one compressible member 18 attached to the outer edge 16 of the at least one material portion 14 and extending beyond the perimeter boundary of the at least one material portion 14, wherein the at least one compressible member 18 comprises a first and a second opposed end attached to the outer edge 16 of the at least one material portion 14, wherein the compressible member 18 forms at least one arc (shown generally at 22 (FIG.3)) between the first and second opposed ends when attached to the outer edge 16 of the material portion 14, wherein the at least one compressible member 18 has an open configuration associated with an open state of the shade 14, and a collapsed configuration associated with a collapsed state of the shade 14, and wherein the at least one compressible member 18 in the open configuration is adapted to transfer compressive forces to said outer edge 16 of the material portion 14.

The material or shade portion 14 may be stretchable. Preferably, the material portion 14 is stretchable in two opposed directions. This may be accomplished by the utilization of stretchable fabric. Therefore, and in one embodiment of the invention, the shades comprise a stretchable fabric. It should be noted, however, that the shades might comprise a material that is not stretchable. The material portion may be pleated or adapted to be folded in accordance with the invention.

In accordance with the invention, at least one compressible member 18 is attached to material portion 14. The compressible member 18 of the invention extends beyond the perimeter or outer edge 16 of the material portion 14 and is adapted to conform to an edge or perimeter of a window, door, or other similar structure in which the shade is to be installed, while maintaining the material portion 14 in an open position and supplying an expansive force to hold the shade 12 in place in the open position.

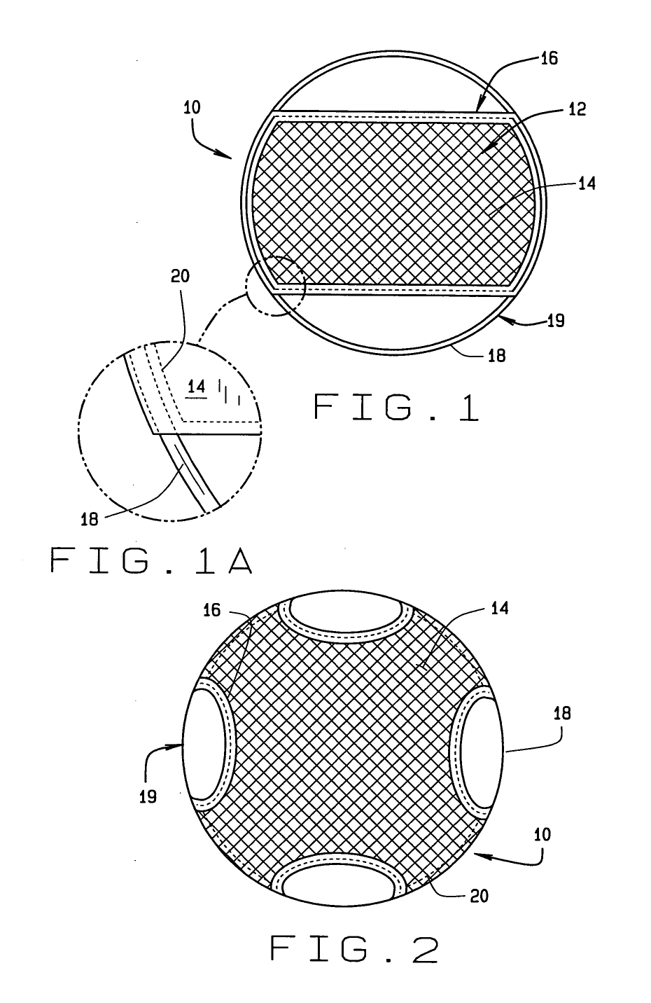

With reference to FIG. 1, one embodiment of the support structure 10 associated with a collapsible shade 12 is disclosed. The collapsible shade 12 includes a material portion 14 of fabric-like material, which may be cloth, mesh, polymer, or even Mylar®. Preferably, the material easily deforms into any shape without a memory. When the shade 12 is expanded, as shown in FIG. 1, the material portion 14 is held in an open configuration, in this particular instance being generally rectangular, and which can be used as a sunshade or privacy screen, internally of an automobile windshield, door, or window. As one skilled in the art can appreciate, the shade 12 of the invention may be used as a shade, or a shade for a window or a door of a house or other structure. The invention is not limited to shades. The outer edge 16 of the material portion 14 defines a perimeter boundary or border, which in this illustrative embodiment is made from simply rolling the outer edge back on itself and securing the edge by sewing.

It will be recognized by those of ordinary skill in the art that the particular shape for the material portion 14 may undertake various configurations, and such shapes may include the rectangular form as shown in FIG. 1, a square form as shown in FIG. 2, or an oval, circular, or truncated configuration, depending upon the particular window or opening automobile make and model for which the screen 12 is intended for use.

As seen in the embodiments of FIGS. 1 and 2, the support structure 10 comprises a spring-like compressible member 18 extending beyond a portion of the outer edge 16 of the material portion 14. The compressible member 18 is a single continuous length of spring-like or resiliently compressible material, such as a thin metal or plastic band having an inherent shape memory, forming a circular framework for supporting the material portion 14 in an open configuration. The spring-like or resilient nature of the compressible member 18 permits the collapsible shade 12 to be reversibly twisted in upon itself in a conventional manner, into a compact and overlapping collapsed configuration suitable for storage. The compressible members comprising the support assembly are adjustable to alter the extension of each of the compressible members beyond the perimeter of the shade material. A slide clasp is configured to permit each compressible member to slide along the perimeter of the shade, between a fully extended position having maximum displacement from the perimeter of the shade material, and a retracted position adjacent the perimeter of the shade material. Each compressible member is configured to adjust as required to facilitate the installation of the shade in automobile windows of varying shapes and sizes.

Preferably, the compressible member 18 and the material portion 14 are coupled by incorporating the compressible member 18 into the outer edge 16 or border of the material portion 14.

In a third embodiment, shown in FIG. 3, a single compressible member 18 forms an arcuate framework 22 for supporting the material portion 14 in an open configuration. The arcuate framework 22 is secured to the perimeter boundary of the material portion 14 in a conventional manner at two fixed attachment points 24A, 24B, such as by the use of fasteners adapted for crimping or clamping. The fastener could also be a releasable attachment in accordance with the invention. A hook and loop fastener, such as Velcro®, which is commercially available from Velcro Industries B.V., may be used in accordance with the invention for a releasable attachment. Alternatively, as shown by a variation of the third embodiment in FIG. 4, the arcuate framework 22 may include a centrally disposed third fixed attachment point 24C, forming a pair of arcuate elements 22A, 22B adjacent one edge of the material portion 14 from the single compressible member 18.

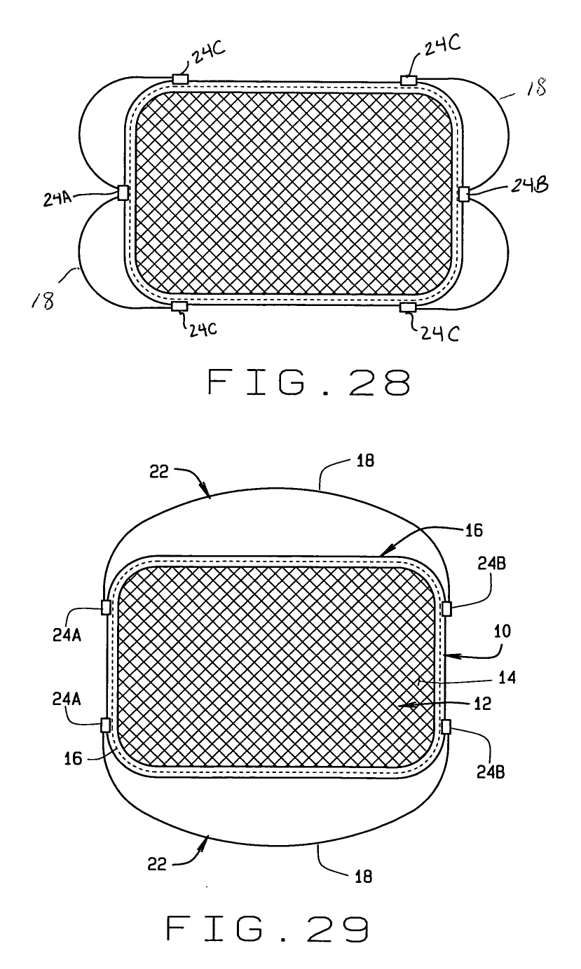

In a fourth embodiment shown in FIG. 5, a single compressible member 18 is disposed in a generally circular configuration 26 about the outer edge 16 of the material portion 14, in an open configuration. Unlike the embodiment shown in FIG. 1, the material portion 14 in this embodiment is secured to the compressible member 18 by a plurality of fixed attachment points 24A, 24B, 24C, and 24D in spaced relationship about the perimeter boundary of the material portion 14. As illustrated in FIG. 29, and in an alternative embodiment of the invention, the compressible member 18 may or may not be parallel to the side portions of the material portion 14, when disposed in a circular configuration 26 about the outer edge 16 of the material portion in an open configuration.

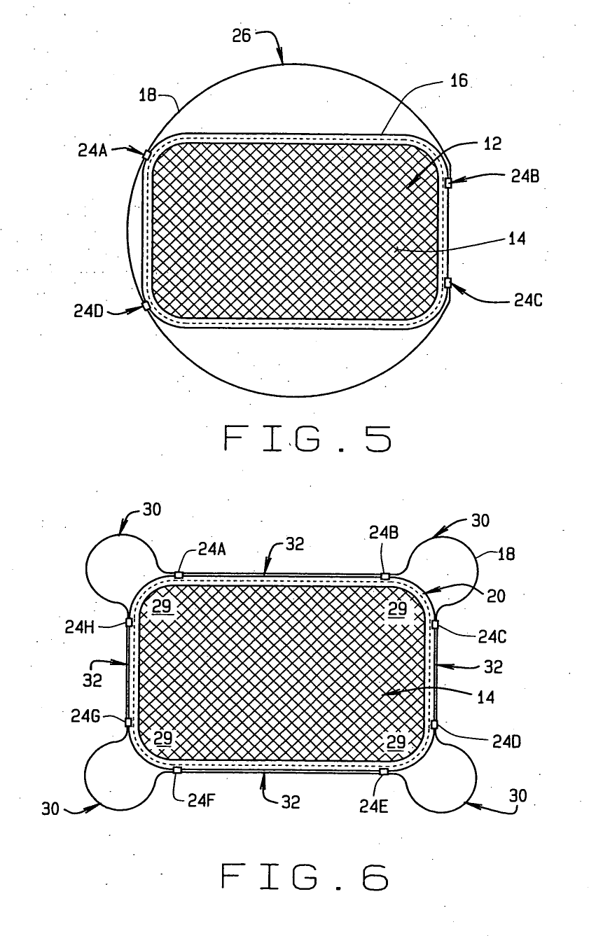

In a fifth embodiment shown in FIG. 6, a single compressible member 18 is disposed about the outer edge 16 of the material portion 14 in an open configuration. The compressible member 18 is secured to the outer edge 16 of the material portion 14 by a plurality of fixed attachment points 24A-24H, such that portions 30 of the compressible member 18 adjacent corner regions 29 of the material portion 14 are spaced apart therefrom and, as shown, form segments of circles, while portions 32 of the compressible member 18 adjacent the elongated sides of the material portion 14 are substantially parallel thereto.

It should be noted, however, that variations to the embodiments illustrated in FIGS. 5 and 6 are within the scope of the present invention. With reference to FIG. 29, the first and second opposed ends of the at least one compressible member 18 may be attached to either the upper portion of the outer edge 16 of the material portion 14, thereby forming a single arc between the first and second opposed ends on the upper portion of the outer edge 16 of the material portion 14, or the lower portion of the outer edge 16 of the material portion 14, thereby forming a single arc between the first and second opposed ends on the lower portion of the outer edge 16 of the material portion 14. The material portion 14 includes an upper and a lower portion. A division along a horizontal line, which bisects the material portion 14, defines the portions. The material portion 14 may also be divided into two side portions. A vertical line that bisects the material portion 14 defines the side portions. These portions are illustrative only, and meant to aid in the description of the material portion 14. Accordingly, these portions are approximations and may overlap one another. A single arc may also be formed between the first and second opposed ends on both the lower and upper portion of the outer edge 16 of the material portion 14 in accordance with the invention.

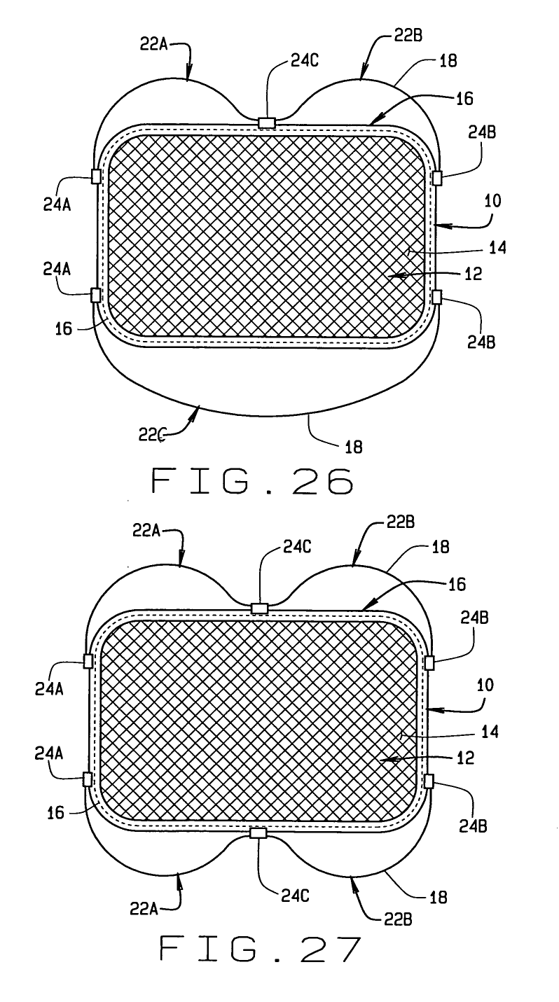

The shade 12 of the invention may comprise at least one compressible member 18 that is attached to the outer edge 16 of either the upper or lower portion of the material portion 14 at the first and second opposed ends and at a midline of the compressible member 18, as seen in FIG. 26, thereby forming two arcs 22A and 22B between the first and second opposed ends on either the upper or lower portion of the material portion and a second compressible member 18 attached to the outer edge 16 of either the upper or lower portion of the material portion 14 at the first and second opposed ends, thereby forming a single arc 22C between the first and second opposed ends on either the upper or lower portion of the material portion 14. In this embodiment, the first and second compressible members 18 are not attached to the same portion of the outer edge 16 of the material portion 14. However, in an alternative embodiment, both a first and second compressible member 18 form two arcs 22A and 22B, between the first and a second opposed ends on both the lower portion of the outer edge 16 of the material portion 14 and the upper portion of the outer edge 16 of the material portion 14. This alternative embodiment is illustrated in FIG. 27.

In one alternative embodiment of the invention shown in FIG. 26, a single compressible member 18 is disposed in an arced configuration 26 about the outer edge 16 of the material portion 14, in an open configuration. The compressible member may be attached to the upper portion of the outer edge 16 of the material portion 14 at the first and second opposed ends, and at a midline or center of the compressible member, thereby forming two arcs 22A and 22B between the first and second opposed ends on the upper portion of the outer edge 16 of the material portion 14 in accordance with the invention. Unlike the embodiment shown in FIG. 1, however, the material portion 14 in this embodiment is secured to the compressible member 18 by a plurality of fixed attachment points 24A and 24B in spaced relationship about the bottom portion of the perimeter boundary 16 of the material portion 14. Unlike the embodiment shown in FIG. 5, however, the upper portion of the outer edge 16 of the material portion 14 is secured to the outer edge 16 of the material portion 14 by a plurality of fixed attachment points 24A, 24B and 24C, such that portions of the compressible member 18 adjacent the top portion of the material portion 14 form two arches 22A and 22B.

In accordance with the invention, and with reference to FIGS. 26 and 27, the compressible member 18 may be attached to the lower portion of the outer edge 16 of the material portion 14 at the first and second opposed ends and at a midline or center of the compressible member 18, thereby forming two arcs 22A and 22B between the first and second opposed ends on the lower portion of the outer edge 16 of the material portion 14. The shade 12 of the invention may comprise a first compressible member 18 that is attached to the upper portion of the outer edge 16 of the material portion 14 at the first and second opposed ends and at a midline of the compressible member 18 and a second compressible member 18 that is attached to the lower portion of the outer edge 16 of the material portion 14 at the first and second opposed ends and at a midline of the compressible member 18, thereby forming two arcs 22A and 22B between the first and second opposed ends on the lower portion of the outer edge 16 of the material portion 14 and on the upper portion of the outer edge 16 of the material portion 14.

In one embodiment of the invention, the segments of arches 22A and 22B may be formed adjacent the side portions of the material portion 14, as seen in FIG. 28. In this embodiment of the invention, the shade 12 comprises a compressible member 18 that is attached to a first side portion of the outer edge 16 of the material portion 14 and a second compressible member 18 that is attached to a second side portion of the outer edge 16 of the material portion 14. In alternative embodiments, the collapsible shade 12 comprises a compressible member 18 that is attached to the first side portion of the outer edge 16 of the material portion 14 at its opposed ends and at a midline or center of the compressible member. Compressible member 18 may also be attached to both side portions, in accordance with the invention and as illustrated in FIG. 28, thereby forming two arcs 22A and 22B between the first and second opposed ends on the first side portion of the outer edge 16 of the material portion 16 and the second side portion of the outer edge 16 of the material portion 14.

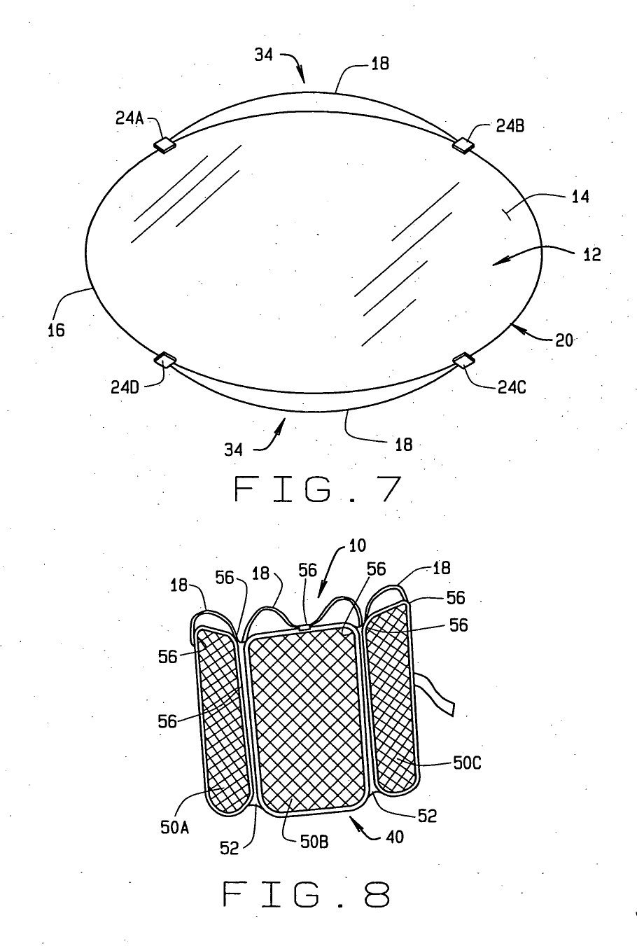

In a sixth embodiment shown in FIG. 7, a pair of compressible members 18 are disposed in spaced relationship about the outer edge 16 of the material portion 14 in an open circular configuration. Each compressible member 18 forms an arcuate framework 34 spaced apart from the outer edge 16 for supporting the material portion 14 in an open configuration. The compressible members can be formed from either one section or two sections of metal or plastic bands. If formed from two sections, then the two metal or plastic bands can be joined together by appropriate means, such as a clamp. Each arcuate framework 34 is secured to the perimeter boundary of the material portion 14 at two fixed attachment points 24A, 24B and 24C, 24D, respectively.

In a seventh embodiment shown in FIG. 8, the support structure 10 is adapted for use with a conventional folding shade 40 comprising a number of rigid shade panels 50A, 50B, and 50C. The shade 40 is configured to fold in a conventional manner along seams 52 disposed between each shade panel 50A, 50B, and 50C, from an open configuration to a closed configuration. The adapted support structure 10 includes a compressible member 18 associated with each rigid shade panel 50A, 50B, and 50C. Each compressible member 18 forms an arcuate framework for supporting the associated rigid shade panel 50A, 50B, and 50C in an open configuration, and is secured to an outer edge of the associated rigid shade panel at two or more fixed attachment points 56.

In a variation of the seventh embodiment shown in FIG. 9, only a limited number of the individual rigid shade panels 60A-60E comprising a conventional folding shade 60 are provided with associated compressible members 18 of the support structure 10.

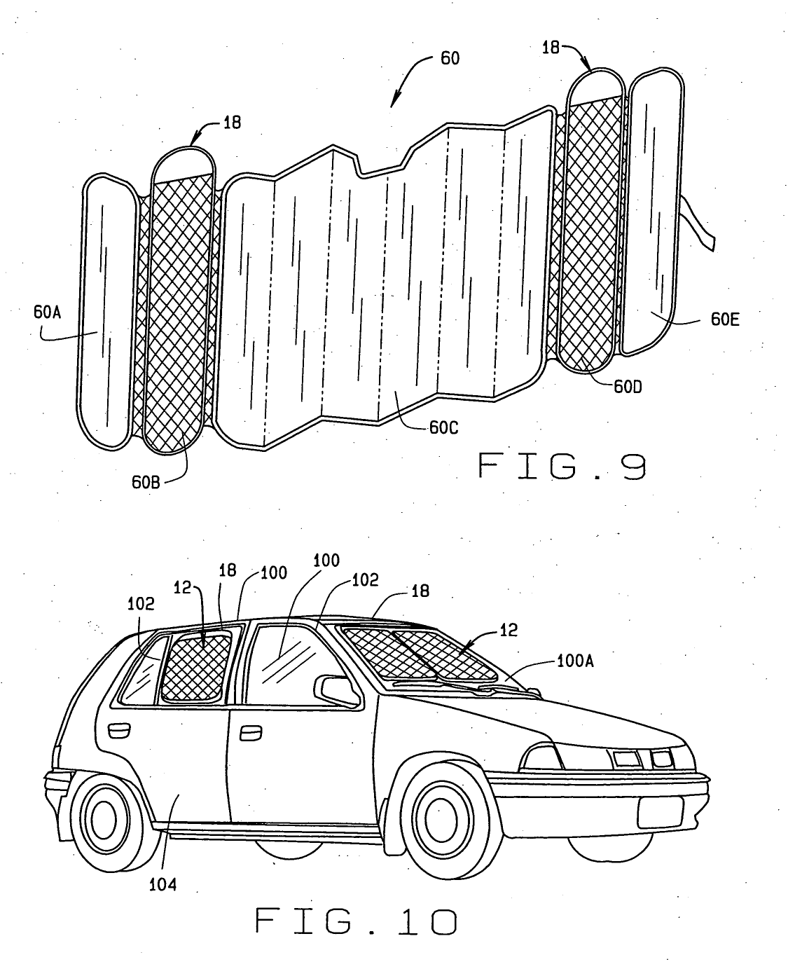

FIGS. 10 and 11 illustrate the use and operation of the support structure 10 of the present invention to secure a collapsible shade 12 in an automobile window 100. The collapsible shade 12 is initially unfolded or expanded to a fully open configuration such as shown in FIGS. 1-9. One side of the compressible member 18 is first placed into the window frame. Generally, the portion of the compressible member 18 that is adjacent to the upper portion of the material portion 14 is placed into the window frame. The other portion of the compressible member 18, generally the lower portion, is then manipulated by pulling or pushing, such that the opposite portion of the shade 12 is able to fit into the desired window. The compressible member 18 is then released and the shade 12 is secured in the window by tension force. As one skilled in the art can readily appreciate, the shade 12 of the invention may be installed by placing the portion of the compressible member 18 that is adjacent to the end of the screen 14 into the window first. Then, the portion of the compressible member 18 that is adjacent to the other end of the screen 14 is placed into the window frame by bending or otherwise manipulating compressible member 18.

Preferably, the shade 12 is selected to include a material portion 14 having overall dimensions equal to or smaller than those of the frame 102 of the window 100 or opening in which it is to be installed, and to include a compressible member 18 having the combined maximum dimensions of the support structure 10 and the material portion 14 that are greater than at least one corresponding dimension of the window 100, or opening. For example, it is preferable that for an automobile window having a 20.0-inch height dimension, collapsible shade 12 has a height of the material portion 14, combined with that of the compressible member 18, which exceed 20.0 inches.

The shade of the invention may also be installed in an automobile widow by using the car's visor, widow frame, sunroof, moon roof or dashboard to hold the shade in place. When installed against the automobile window 100, the components of the support structure 10 are reversibly deformed and compressed to fit within the frame 102, providing tensioned support for the material portion 14 by transferring the compressive loads to the outer edge 16 of the material portion 14. For example, turning to FIG. 10, an embodiment of the present invention shown in FIG. 1 is shown installed in the automobile window 100 of a rear door 104. It should be noted that in circumstances where the outer edge 16 of the material portion 14 is not able to come into operable contact with hardware that provides enough tensioned support to enable use of the material portion, all or one of the fixed attachment points 24A, 24B, 24C and 24D may be released to enable compressible member 18 come into operable contact with the a structure that is capable of providing a sufficient level of tensioned support for the material portion 14. In addition, when the fixed attachment points 24A, 24B, 24C and 24D are released, the material portion 14 may be used on a larger window.

A pair of similar shades 12 is seen installed in the windshield 100A. The compressible member 18, initially defining a circular framework within which the material portion 14 is held, is deformed and compressed by the frame 102 into a substantially rectangular configuration, reducing the spacing between the material portion 14 and the compressible member 18 above and below the material portion 14. The inherent shape memory of the spring-like compressible member 18 resists compression by the window frame 102, exerting an outwardly directed holding force against the window frame 102, maintaining the shade 12 in position against the window 100.

Each embodiment of the support structure 10 shown in FIGS. 1-9 is utilized in a similar manner to that described above. As shown in FIG. 11, the embodiment of the present invention shown in FIG. 6 is illustrated in use to secure a shade 12 in an open configuration against a rear window 100B of an automobile. Specifically, each of the portions 30 of the compressible member 18 adjacent corner regions 29 of the material portion 14 are compressed against the corresponding corners of the rear window frame 102B, providing a tensioning support to maintain the shade 12 in place against the rear window 100B.

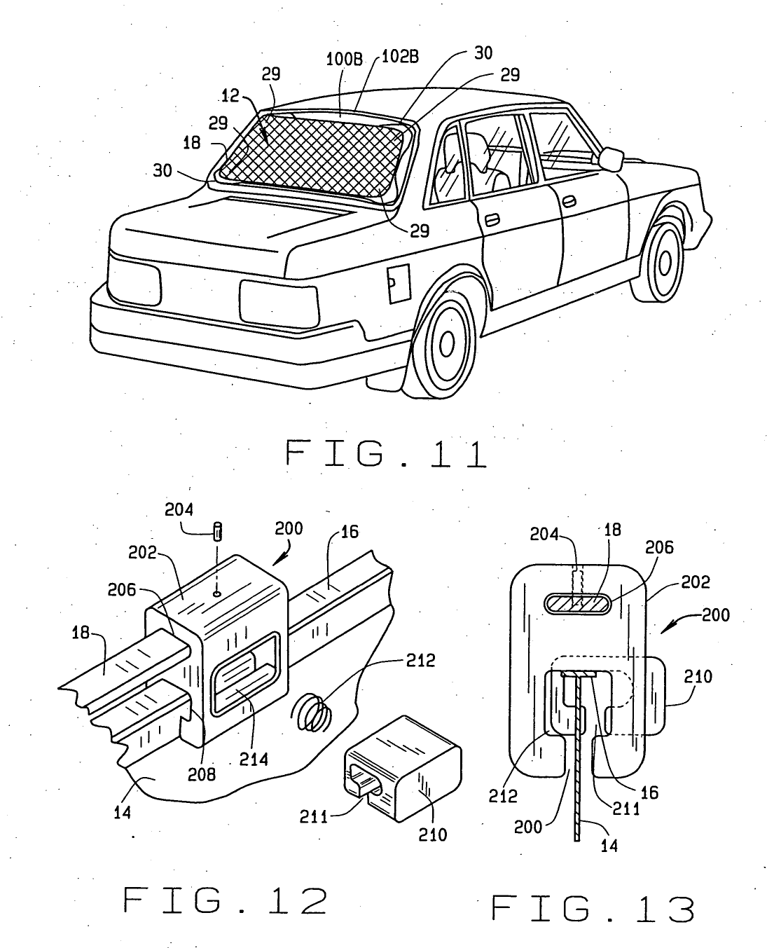

For some applications of the support structure 10, it is desirable to alter the spacing between the compressible members 18 and the shade material 14, so as to permit a shade 12 including the support structure 10 to be utilized in automobile windows 100 having a wide range of dimensions. Turning to FIGS. 12 and 13, an alternate embodiment of the support structure 10 is shown to include a slide coupler 200 utilized in place of a fixed attachment point to secure the compressible member 18 to the outer edge 16 of the shade material 14. The slide coupler 200 comprises a coupler body 202, which is secured to one end of the compressible member 18, preferably by a locking dowel 204 or other conventional attachment means passing through the compressible member 18 seated in a recess 206, and engaging the coupler body 202. The coupler body 202 further includes a channel 208 into which the outer edge 16 of the shade 12 is seated. A release button 210, biased by a spring 212 is seated in a bore 214 intersecting the channel 208. The release button 210 includes a second channel 211 aligned parallel with the channel 208, and is biased by spring 212 to exert a locking pressure against the outer edge 16, securing the slide coupler 200 against sliding movement relative to the outer edge 16. When in the biased (locking) position, a portion of the release button 210 protrudes from the bore 214, beyond the face of coupler body 202.

When depressed inward towards the coupler body 202, the release button 210 compresses the spring 212, and shifts the second channel 211 into longitudinal alignment with the channel 208. When channel 208 and the second channel 211 are in longitudinal alignment, the slide coupler 200 is capable of sliding movement along the outer edge 16. When released, the release button 210 is biased outward from the coupler body 202 by the spring 212, moving the second channel 211 into parallel alignment with the channel 208, and trapping a portion of the outer edge 16 therebetween. The trapped portion of the outer edge 16 resists sliding movement by the slide coupler 200, securing the compressible member 18 in a fixed location relative thereto.

Using the slide coupler 200 it is possible to alter the spacing between the compressible members 18 and the shade material 14, so as to permit a shade 12 including the support structure 10 to be utilized in automobile windows 100 having a wide range of dimensions. Specifically, by sliding the slide coupler 200, and accordingly, the compressible member 18 along the outer edge 16 of the shade 12, the displacement of portions of the compressible member 18 from the outer edge 16 will either increase or decrease, permitting use of the shade and support structure 10 in either larger or smaller windows.

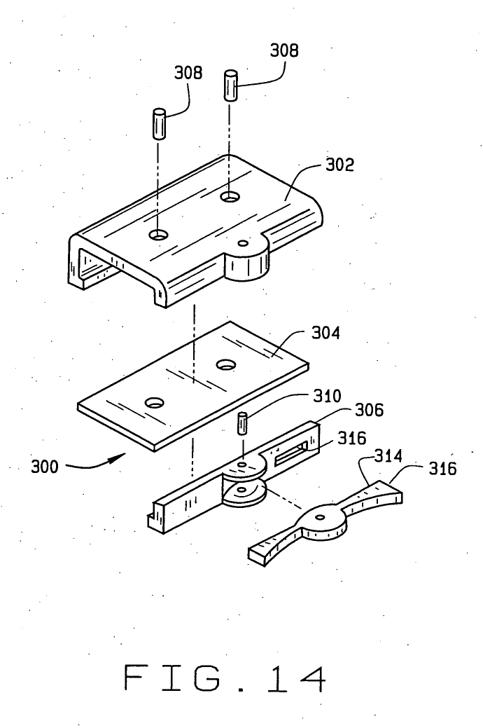

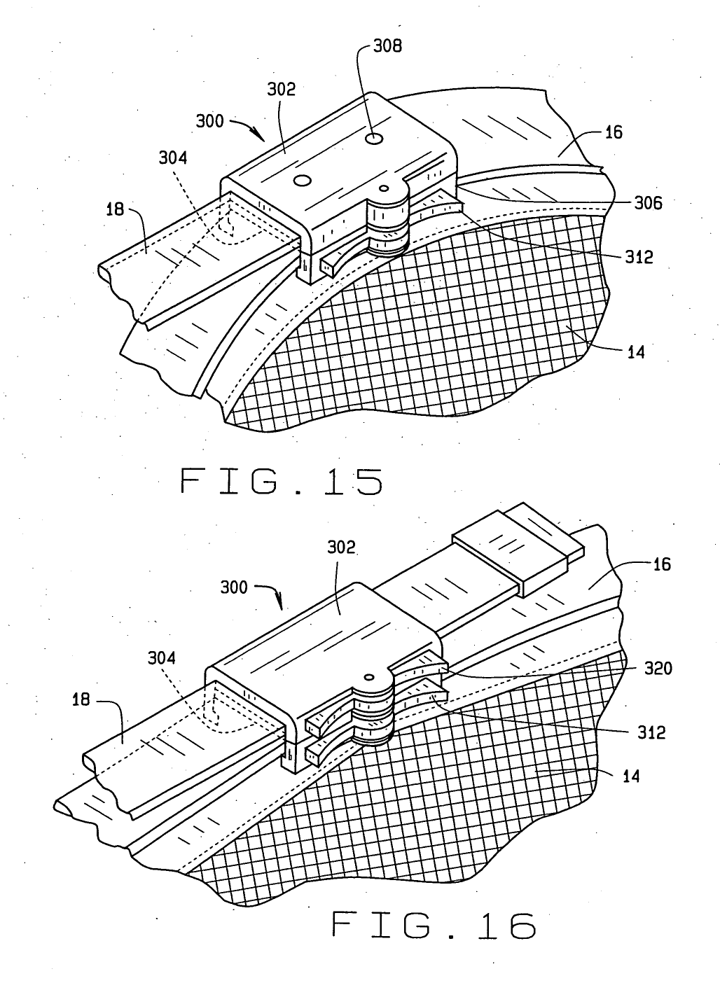

Turning to FIGS. 14 and 15, a first alternate embodiment of the slide coupler suitable for use on a shade 12 having a rigid outer edge 16 is shown. The slide coupler 300 includes an upper clamp plate 302, a lower clamp plate 304, and a faceplate 306. One end of a compressible member 18 is secured between the upper clamp plate 302 and the lower clamp plate 304 by a pair of locking dowels 308 passing through aligned bores in the clamp plates and the compressible member 18. The faceplate 306 is bonded to an edge of the upper clamp plate 302, and provides a pivot 310 for a cam lever 312. The cam lever 312 includes a cam surface 314 in alignment with an opening 316 in the faceplate 306.

As best seen in FIG. 15, when installed as part of a support structure 10, the slide coupler 300 is secured to a rigid outer edge 16 of a shade by the lower retaining lip on the upper clamp plate 302 and the face plate 306. The rigid outer edge 16 is further aligned with the opening 316 in the faceplate 306, such that the cam surface 314 is engaged thereto. Depressing the cam lever 312 rotates the cam surface 314 about the pivot 310, away from the outer edge 16, permitting the slide coupler 300 and attached compressible member 18 to slide along the outer edge 16. When a desired position is reached, the cam lever 312 is released, and the cam surface 314 again engages the outer edge 16 through the opening 316, securing the slide coupler 300 in a fixed position relative to the outer edge 16.

Turning to FIG. 16, a variation of the slide coupler 300 is shown to include a second cam lever 320 in place of the locking dowels 308. The second cam lever 320 operates identically to the cam lever 312, but instead engages an edge of the compressible member 18 through a correspondingly positioned opening. Absent the engagement of the second cam lever 312, the compressible member 18 is free to slide through the slide coupler 300. When engaged by the second cam lever 312, the compressible member 18 is fixed in place relative to the slide coupler 300. By providing a pair of cam levers 312, 320, the slide coupler location may be moved about the outer edge 16 of the shade 12. The length of the compressible member 18 may be adjusted by controlled movement through the slide coupler 300.

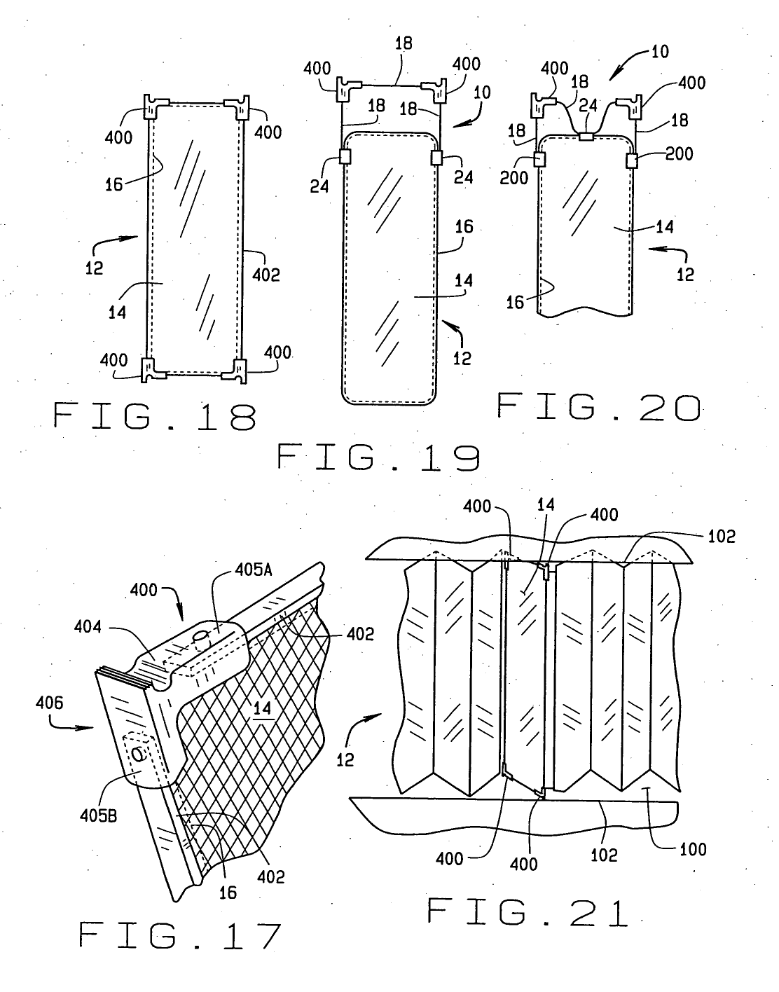

To facilitate holding a shade 12 in a vehicle window, one or more rigid mounting elements 400, such as shown in FIG. 17 through FIG. 21 may be utilized. The support assembly includes one or more rigid mounting elements, or mounting elements, spaced about the perimeter of the collapsible shade. Each rigid mounting element is configured to grip or seat on an edge or perimeter of an automobile window in which the shade is installed, supplying a holding force to secure the shade in place in the open position. The mounting elements are disposed at the corners of the collapsible shade, and are interconnected by the compressible members, which provide an expansive force to seat the rigid mounting elements against the edge or perimeter of an automobile window in which the shade is installed in an open position. Preferably, a plurality of rigid mounting elements 400 is disposed in a spaced relationship about the perimeter of the shade 12, at each corner of the shade material 14 or support structure 10. Each rigid mounting element 400 is secured to either a framework 402 incorporated into the outer edge 16 of the shade material 14, or to elements of the support structure 10, such as a compressible member 18. Preferably, each rigid mounting element 400 includes an L-shaped body 404 defining a pair of extensions 405A, 405B, and having a friction surface 406 disposed at the apex. Each extension 405A and 405B is configured to receive either a portion of the framework 402 as shown in FIGS. 17, 18, and 21, or elements of the support structure 10 as shown in FIGS. 19 and 20, in a fixed relationship.

During use, when the shade 12 is in an open configuration such as shown in FIG. 21, and placed in a window 100 of an automobile, the friction surface 406 on each rigid mounting element 400 seats against the framework 102 surrounding the window 100, to provide a positive contact against which the shade 12 and/or support structure 10 can exert a holding force to maintain the shade 12 in place adjacent the window 100.

An alternative shade 500 is shown in FIG. 22. The shade 500 is similar to the shade 10 of FIG. 3, but which is provided with a pocket 502. The shade 500, like the shade 10, includes a screen 504. To form the pocket 502, the shade is provided with a second layer 506 of material, which overlies the first layer 504 of screening material. The second layer 506 of material is preferably as wide as the first layer of screening material 504, so that the two layers of material can be joined at their periphery. Additionally, the lower edge of the second layer 506 is joined to the lower edge of the first layer 504, to form a bottom of the pocket 502. Although the layer 506 is shown to have a height equal to the height of the layer 504, the second layer can have a height less than the height of the first layer, in which case, the pocket 502 will have a depth less than the height of the screen 504. Additionally, the second layer 506 can be mounted to the first layer 504, such that the bottom of the second layer (and hence the bottom of the pocket 502) is above the bottom of the first layer 504.

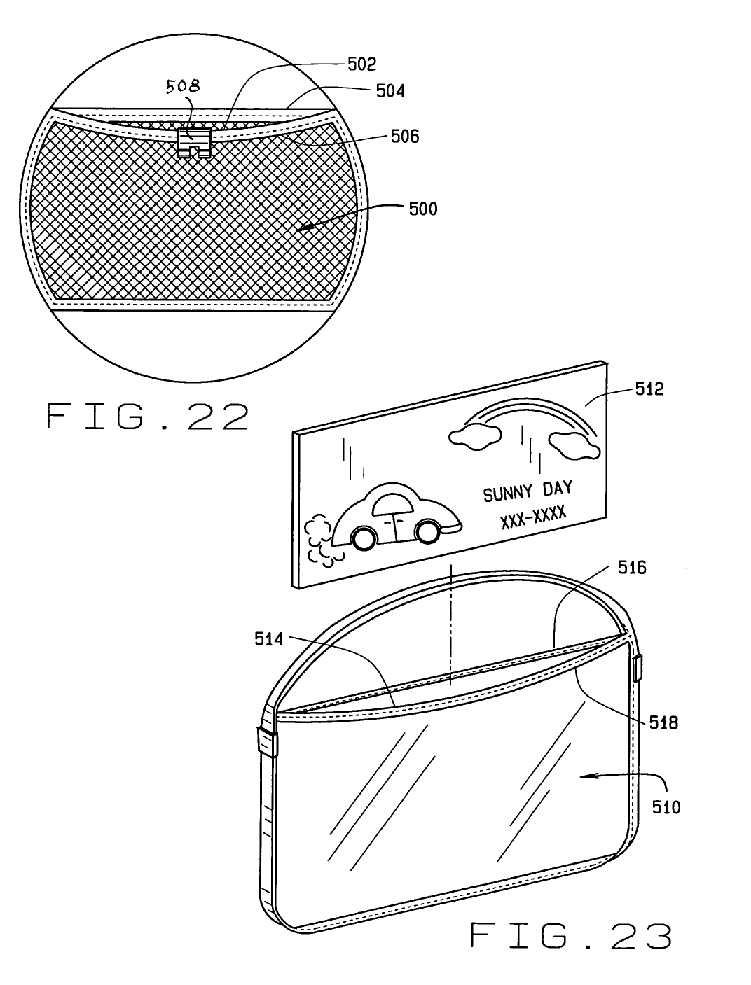

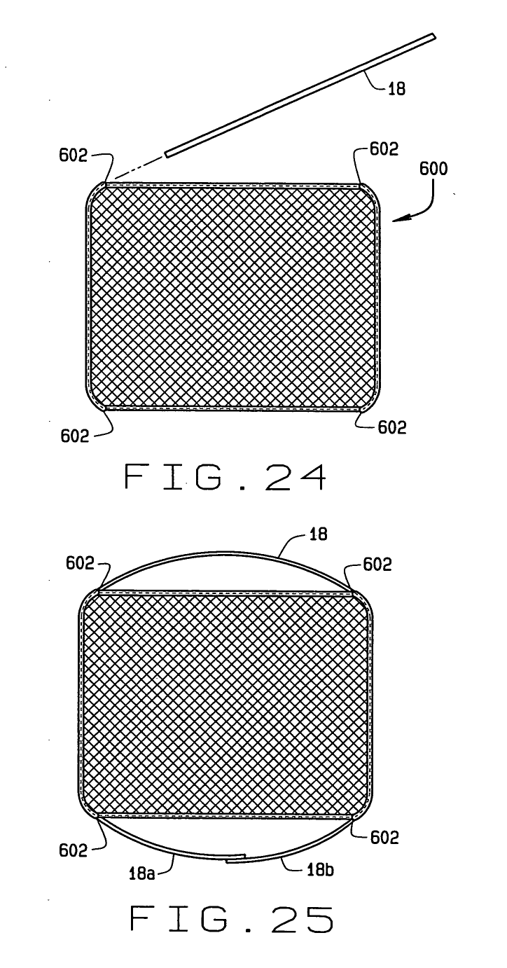

A second pocketed shade 510 is shown in FIG. 23. The shade 510 is constructed similarly to the shade of FIG. 3 and is provided with a pocket in the same manner as discussed above in conjunction with the shade 500. The shade 510 is shown to be able to receive a plaque or sign 512. This sign 512 can simply be decorative. Alternatively, the sign 512 can contain a message, such as “Send Help”. To facilitate insertion of the sign 512 into the pocket 514 of shade 510, the first and second layers 516 and 518 are preferably made from stretchable material. Further, the material from which the layers are made can stretch along two axes so that the material can be stretched in two opposing directions (i.e., widthwise and height wise). Additionally, to enable the plaque 512 to be seen, the second layer 518 of material is preferable transparent or made from an open mesh.

In view of the usage of the pocket or pouches that can be formed into the shades, as shown in these FIGS. 22 and 23, it is also likely that a clip, such as shown at 508, could be added to the margin of the shown pocket, and hold a sign, plaque, or even a cautionary message, as previously reviewed, externally of the pocket, to provide for means for holding such signage in position during its installation.

In FIGS. 24 and 25, a shade 600 is shown which is similar to the shade 10 of FIG. 3. However, in the shade 600, the perimeter of the screen forms pockets or openings 602, there being two opposed openings 602 along the top edge of the screen and two opposed openings 602 along the bottom edge of the screen. The compressible member 18 is then received in opposed openings 602, as shown in FIGS. 24 and 25. As seen in FIG. 24, the compressible member 18 can be formed from a single piece, in which case, the member 18 has a length greater than the length of the edge of the shade 600, such that the compressible member will bow or bend outwardly from the screen of the shade. As seen in FIG. 25, the compressible member can be comprised of a pair of shorter members 18a, b, which have a combined length greater than that of the edge of the shade. The ends of the two members 18a, b are then joined together by an appropriate connector.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A collapsible shade for use in compressing against the window structure of a vehicle after installation, comprising:
at least one material portion having an outer edge defining a perimeter boundary;
at least one compressible member attached to the outer edge of the at least one material portion and extending beyond the perimeter boundary of the at least one material portion;
wherein said at least one compressible member comprises a first and a second opposed end attached to the outer edge of the at least one material portion;
wherein said compressible member forms at least one arc between the first and second opposed ends when attached to the outer edge of the material portion, said arc disposed for compressing against the window structure of a vehicle when installed;
wherein said at least one compressible member has an open configuration associated with an open state of said shade, and a collapsed configuration associated with a collapsed state of said shade; whereby said shade and its compressible member are reversibly twisted into a compact and overlapping collapsed configuration of reduced size to facilitate its storage during nonusage; and
wherein said at least one compressible member in said open configuration is adapted to transfer compressive forces to said outer edge of said material portion.

2. The collapsible shade of claim 1 comprising two compressible members.

3. The collapsible shade of claim 2 wherein a first of the compressible members is attached to a first portion of the outer edge of the material portion and a second of the compressible members is attached to a second portion of the outer edge of the material portion, said second portion being opposed to the first portion.

4. The collapsible shade of claim 3 wherein the first and second opposed ends of the first compressible member are attached to the first portion of the outer edge of the material portion, thereby forming a single arc between the first and second opposed ends of the first compressible member.

5. The collapsible shade of claim 3 wherein the first and second opposed ends of the second compressible member are attached to the second portion of the outer edge of the material portion, thereby forming a singe arc between the first and second opposed ends of the second compressible member.

6. The collapsible shade of claim 3 wherein the first and second opposed ends of the first compressible member are attached to the first portion of the outer edge of the material portion, thereby forming a singe arc between the first and second opposed ends of the first compressible member, and the first and second opposed ends of the second compressible member are attached to the second portion of the outer edge of the material portion, thereby forming a singe arc between the first and second opposed ends of the second compressible member.

7. The collapsible shade of claim 3 wherein at least one of the compressible members is attached to the outer edge of the material portion at the first and second opposed ends and at a center thereof, thereby forming two arcs between the first and second opposed ends, and said two arcs compressing against the window structure of a vehicle when installed.

8. The collapsible shade of claim 3 wherein the first compressible member is attached to the first portion of the outer edge of the material portion at the first and second opposed ends and at a center of the first compressible member, thereby forming two arcs between the first and second opposed ends of the first compressible member, and said two arcs provided for compressing against the window structure of a vehicle when installed.

9. The collapsible shade of claim 3 wherein the second compressible member is attached to the second portion of the outer edge of the material portion at the first and second opposed ends and at a center of the second compressible member, thereby forming two arcs between the first and second opposed ends of the second compressible member, said two arcs provided for compressing against the window structure of a vehicle when installed.

10. The collapsible shade of claim 3 wherein the first compressible member is attached to the first portion of the outer edge of the material portion at the first and second opposed ends and at a center of the first compressible member, and the second compressible member is attached to the lower portion of the outer edge of the material portion at the first and second opposed ends and at a center of the second compressible member, thereby forming two arcs between the first and second opposed ends of both said first and second compressible member, said two arcs provided for compressing against the window structure of a vehicle when installed.

11. The collapsible shade of claim 3 wherein the first compressible member is attached to the outer edge of the first portion of the material portion at the first and second opposed ends and at a center of the first compressible member, thereby forming two arcs between the first and second opposed ends of the first compressible member, and the second compressible member is attached to the outer edge of either the upper or lower portion of the material portion at the first and second opposed ends, thereby forming a single arc between the first and second opposed ends of the second compressible member, and said arc provided for compressing against the window structure of a vehicle when installed.

12. The collapsible shade of claim 1 wherein said at least one compressible member is releasably attached to the outer edge of the at least one material portion.

13. The collapsible shade of claim 1 further comprising at least one fastener for attachment of the at least one compressible member to the outer edge of the material portion.

14. The collapsible shade of claim 13 wherein the fastener is a hook and loop fastener.

15. The collapsible shade of claim 13 wherein the fastener is at least one of a crimp or clamp.
